(19) United States
(12) Patent Application Publication
(10) Pub. No.: US 2015/0347352 A1
(43) Pub. Date: Dec. 3, 2015

(54) FORM PREVIEW IN A DEVELOPMENT ENVIRONMENT

(71) Applicant: Microsoft Technology Licensing, LLC, Redmond, WA (US)

(72) Inventors: Suriya Narayanan, Redmond, WA (US); Devin Leslie Carraway, III, Seattle, WA (US); Nitinkumar S. Shah, Seattle, WA (US); Dave L. Parslow, Redmond, WA (US)

(21) Appl. No.: 14/506,928

(22) Filed: Oct. 6, 2014

Related U.S. Application Data
(60) Provisional application No. 62/006,626, filed on Jun. 2, 2014.

(51) Int. Cl. G06F 17/21; G06F 17/24

(52) U.S. Cl. CPC G06F 17/211; G06F 17/243

(57) ABSTRACT

A developer interaction input is received on a given portion of a form authoring display. The developer interaction input is correlated with other portions of the display and the other portions of the display are modified to visually reflect the developer interaction with the given portion of the display.

### CROSS-REFERENCE TO RELATED APPLICATION

The present application is based on and claims the benefit of U.S. provisional patent application Ser. No. 62/006,626, filed Jun. 2, 2014, the content of which is hereby incorporated by reference in its entirety.

### BACKGROUND

Computer systems are currently in wide use. Many computer systems have forms or other display mechanisms by which information in the computer system is presented to a user.

As one example, some computer systems include business systems. Business systems can include, for instance, enterprise resource planning (ERP) systems, customer relations management (CRM) systems, line-of-business (LOB) systems, among others. These types of systems can have hundreds or thousands of different forms that are presented to users in different contexts. Each form can have many different (in fact hundreds or thousands of) controls. It can thus be difficult for developers to keep track of how their modifications to such systems affect the forms that actually present the information to the user.

Business systems are but one example of such systems. For instance, electronic mail systems and other messaging systems, as well as electronic storefronts, document management systems and a large variety of other computer systems have forms that present data to users as well. In all of these types of systems, the development task for developing the product or modifying it for a customer's needs can be quite involved.

The discussion above is merely provided for general background information and is not intended to be used as an aid in determining the scope of the claimed subject matter.

### SUMMARY

A developer interaction input is received on a given portion of a form authoring display. The developer interaction input is correlated with other portions of the display and the other portions of the display are modified to visually reflect the developer interaction with the given portion of the display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a development environment.

FIG. 2 is a more detailed block diagram of one example of metadata authoring functionality.

FIG. 3 is a more detailed block diagram of one example of a preview generator.

FIG. 4 is a flow diagram illustrating one example of the operation of the environment shown in FIG. 1 in receiving developer inputs and visually reflecting those inputs on a development surface.

FIG. 4A shows one example of a user interface display reflecting a development surface.

FIG. 5 is a flow diagram illustrating one example of the operation of the environment shown in FIG. 1 in visually reflecting an input where the developer selects a displayed element.

FIG. 6 is a flow diagram illustrating one example of the operation of the environment shown in FIG. 1 in visually reflecting inputs where the developer modifies metadata, properties, or a preview on the development surface.

FIG. 7 is a flow diagram illustrating one example of the environment shown in FIG. 1 in processing developer undocking and docking inputs.

FIG. 8 shows an example of a cloud computing architecture.

FIGS. 9-11 show examples of mobile devices.

FIG. 12 shows a block diagram of one example of a computing environment.

### DETAILED DESCRIPTION

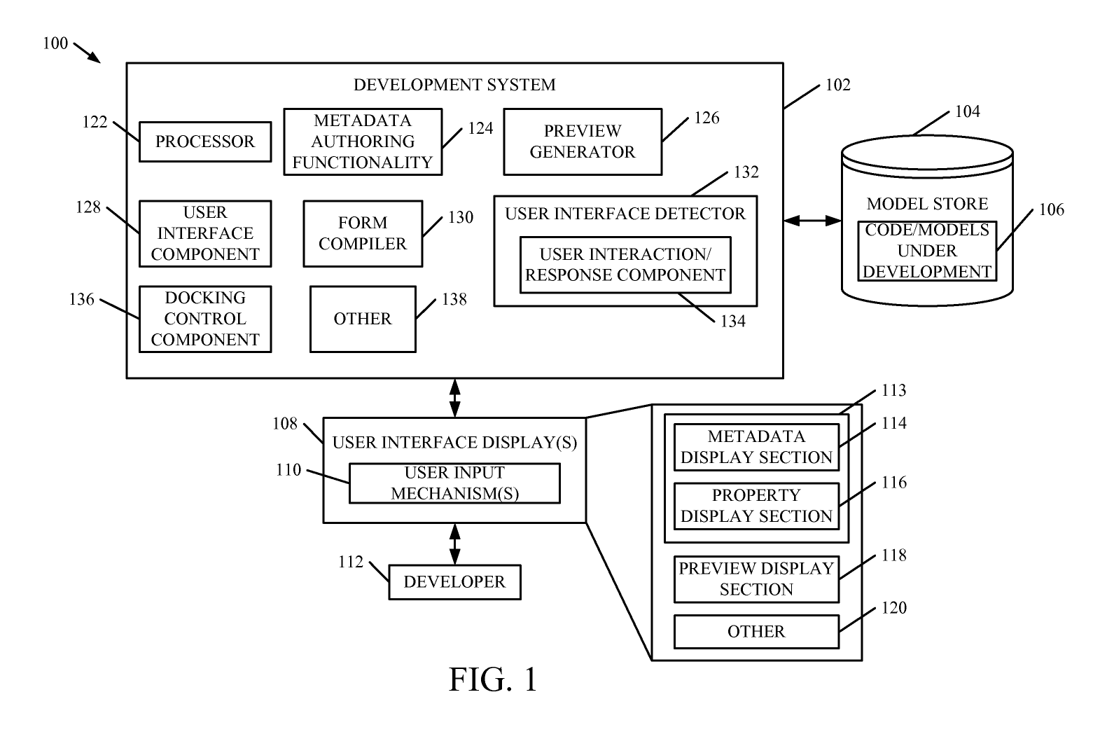

FIG. 1 is a block diagram of one example of a development environment 100. Environment 100 illustratively includes development system 102 which can, for example, be an integrated development environment (or IDE). Development system 102 is shown having access to model store 104 that stores the code or models under development 106. System 102 also illustratively generates user interface displays 108 with user input mechanisms 110 for interaction by developer 112. User interface displays 108 illustratively include a designer surface 113 that includes metadata display section 114 and property display section 116. It also illustratively includes a preview display section 118, and it can include other items 120 as well.

In the example shown in FIG. 1, development system 102 illustratively includes processor 122, metadata authoring functionality 124, preview generator 126, user interface component 128, form compiler 130, user interaction detector 132 (which, itself, illustratively includes user interaction/response component 134), docking control component 136, and it can include other items 138 as well. Before describing the overall operation of environment 100, a brief overview of various components of environment 100 will first be provided.

Metadata authoring functionality 124 is illustratively functionality provided in an IDE or other development tool that allows developer 112 to author metadata or other data that defines forms. For the sake of the present discussion, the term forms will be used to mean any mechanism by which information is displayed to a user.

The code/models under development 106 are, in one example, a code that represents a business system, such as an ERP system, a CRM system, an LOB system, etc. Of course, this is only one example of the code under development, which developer 112 is working on. A wide variety of other systems could embody the code under development as well.

Form compiler 130 illustratively compiles the metadata input by developer 112 in developing forms into a descriptor language that can be understood by browser 127 in preview generator 126. Therefore, browser 127 can use user interface component 128 to display a preview of the form, as it is being authored by developer 112. User interaction detector 132, and user interaction/response component 134, illustratively detect user interactions with the designer surface 113 and the preview display section 118 on user interface displays 108, to determine what type of interaction has been detected, and to determine what type of response is to be provided, in response to that user input.

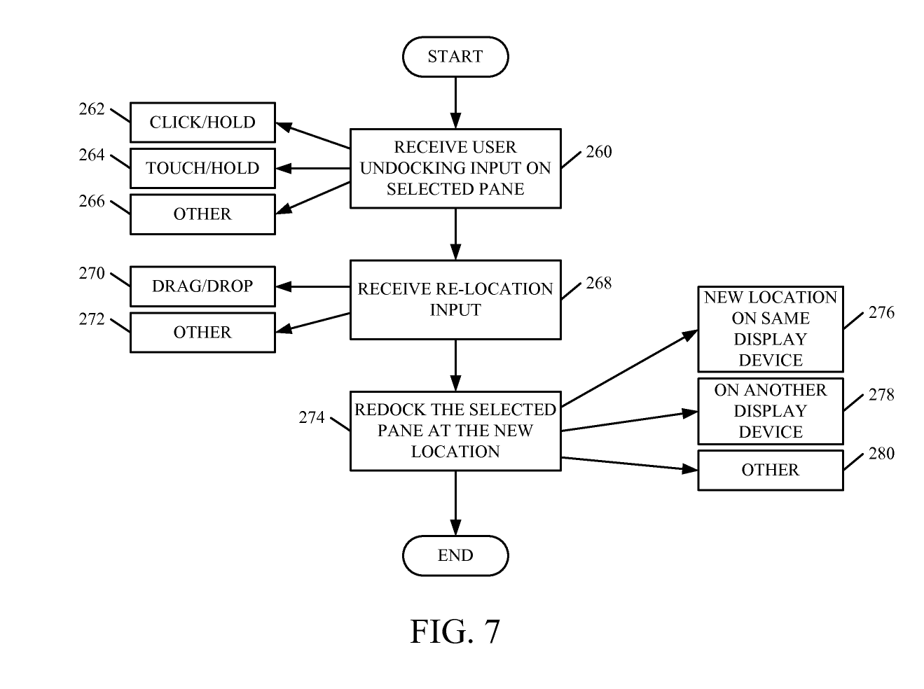

Docking control component 136 illustratively processes developer inputs that indicate that the developer wishes to undock a portion of the user interface display 108 and relocate it on the display device, or on a separate display device. This is described in greater detail below with respect to FIG. 7.

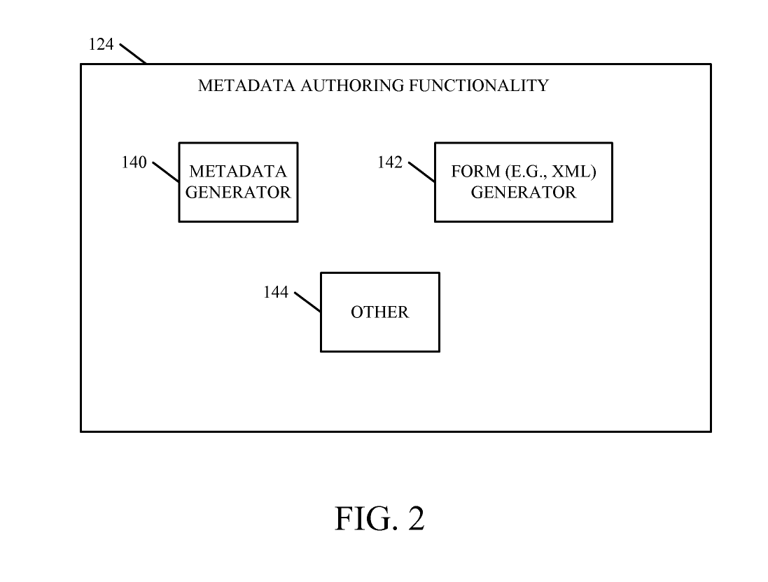

FIG. 2 is a block diagram showing one example of metadata authoring functionality 124 in more detail. FIG. 2 shows that metadata authoring functionality 124 illustratively includes metadata generator 140, form generator (e.g., XML generator) 142, and it can include other items 144 as well. Metadata generator 140 provides functionality that enables developer 112 to author metadata (e.g., create, delete or edit or otherwise modify metadata) on designer surface 113. Form generator 142 illustratively generates an XML (or other markup language) representation of the form described by the metadata.

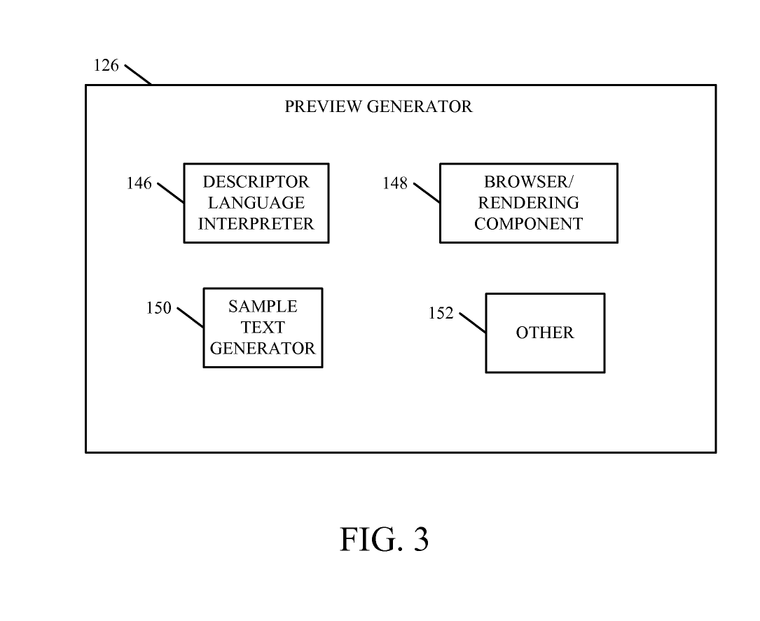

FIG. 3 is a block diagram of one example of preview generator 126, in more detail. In the example shown in FIG. 3, preview generator 126 illustratively includes descriptor language interpreter 146, browser/rendering component 148, sample text generator 150, and it can include other items 152 as well. Descriptor language interpreter 146 illustratively interprets the descriptor language generated by form compiler 130, that represents a form being developed. Browser/rendering component 148 renders the interpreted descriptor language on preview display section 118 of user interface displays 108. As is described in greater detail below, sample text generator 150 can generate sample text that can be placed in the rendered form (in preview display section 118) so that developer 110 can quickly get an idea of what the displayed form will look like, when it is being used in a runtime implementation.

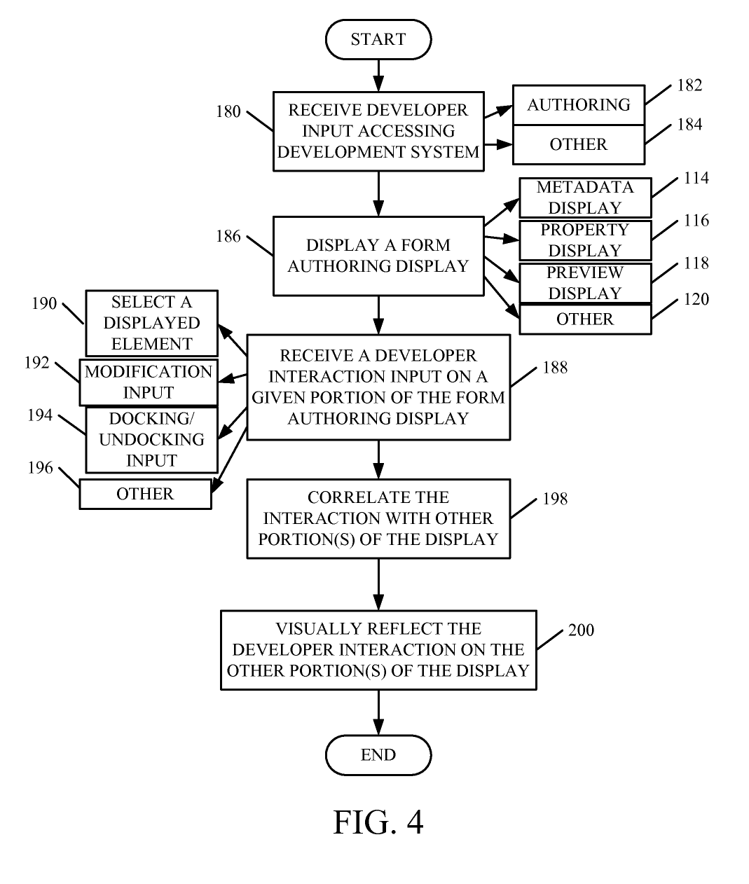

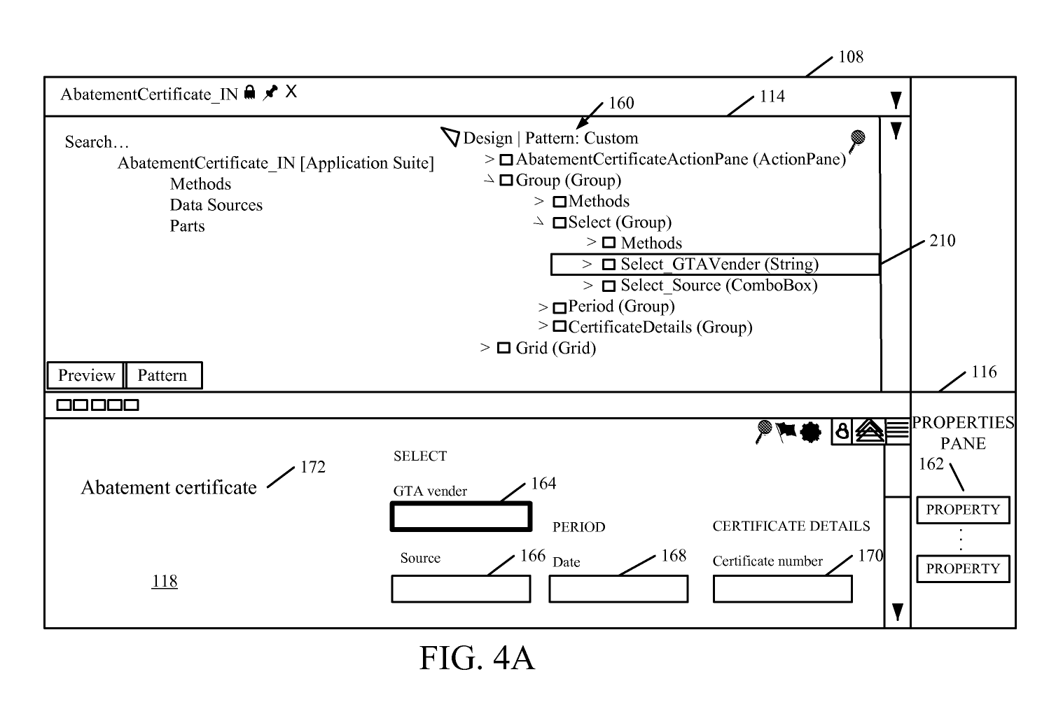

FIG. 4 is a flow diagram illustrating one example of the operation of development system 102 in receiving developer inputs and visually reflecting the result of those inputs on the designer surface 113 and the preview display section 118 of user interface displays 108. FIG. 4A shows one example of a user interface display 108. In the embodiment shown in FIG. 4A, metadata display section 114 and property display section 116 comprise the designer surface 113 of development system 102. They illustratively include components that allow developer 112 to provide inputs to author (e.g., create, modify or delete) metadata in section 114, and to author (e.g., create, modify or delete) properties and property values in property section 116.

FIG. 4A shows that metadata section 114 includes a generally hierarchical metadata structure 160. The metadata in hierarchical structure 160 illustratively defines a form. Property section 116 illustratively includes a set of properties 162 that, in conjunction with the metadata in structure 160, further define the form being developed. FIG. 4A also shows one example of a preview display section 118. In the example shown in FIG. 4A, the form being developed is a form entitled “Abatement Certificate”. It includes a plurality of different controls 164, 166, 168 and 170, it also includes a title 172, among other things. In one embodiment, as developer 112 makes changes to metadata structure 160 or the properties 162, form compiler 130 compiles those changes into a descriptor language that is interpreted and rendered by preview generator 126, so that preview section 118 reflects the developer inputs to the metadata 160 or properties 162.

Likewise, when developer 112 provides inputs on preview display section 118, user interaction detector 130 detects those inputs and user interaction/response component 134 controls user interface component 128 to visually reflect those developer interactions in the other sections (e.g., in either metadata display section 114 or property display section 116, or both). The flow diagram of FIG. 4 will now be described to further illustrate this.

It is first assumed that development system 102 receives a developer input accessing the development system 102. This is indicated by block 180 in FIG. 4. By way of example, after developer 112 has provided authentication information 182 or other information 184, in order to gain access to system 102, developer 112 can navigate to a form authoring environment.

In response, development system 102 illustratively displays a form authoring user interface display 108 so that developer 112 can develop on a given form. Displaying the form authoring display is indicated by block 186. Again, this can include a metadata display section 114, property display section 116, preview display section 118, and it can include other display sections 120.

User interaction detector 132 then receives a developer interaction input on a given portion of the form authoring display. This is indicated by block 188 in FIG. 4. For instance, developer 112 can select a displayed element on any of the portions of display 108 (shown in FIG. 4A). This is indicated by block 190. Developer 112 can provide an authoring input (e.g., creating, modifying, or deleting items) modifying the display, as indicated by block 192. Developer 112 can provide a docking or undocking input that indicates that developer 112 wishes to dock or undock a portion of display 108 and move it to a different location. This is indicated by block 194. The developer 112 can provide other interaction inputs 196 as well.

Component 134 then correlates the user interaction with other portions of the display. This is indicated by block 198 in FIG. 4. System 102 then visually reflects the user interaction on the other portions of the display. This is indicated by block 200.

As an example, assume that the user adds a node to the hierarchical metadata structure 160 shown in FIG. 4A. In one embodiment, form compiler 130 will compile that change and provide it to preview generator 126. The descriptor language provided by form compiler 130 will be interpreted and rendered by preview generator 126 so that the preview section 118 reflects the change made by the developer to hierarchical metadata 160.

By way of example, assume that developer 112 adds a control to the Abatement Certificate form shown in section 118. As soon as that occurs, that change in metadata will be compiled by compiler 132 and preview generator 126 will show the new control on the form displayed in section 118. The same is true for changes to properties 162. By way of example, assume that developer 112 changes the label on a given control. This would comprise changing one of the values of properties 162. As soon as that occurs, form compiler 130 compiles that change and provides it to preview generator 126. Preview generator 126 will then show the control with the new name.

It will be noted that compiler 130 can compile at any desired time or based on any desired trigger. For instance, compiler 130 can compile once every predetermined unit of time, or based on developer input activity, every time the developer saves, etc.

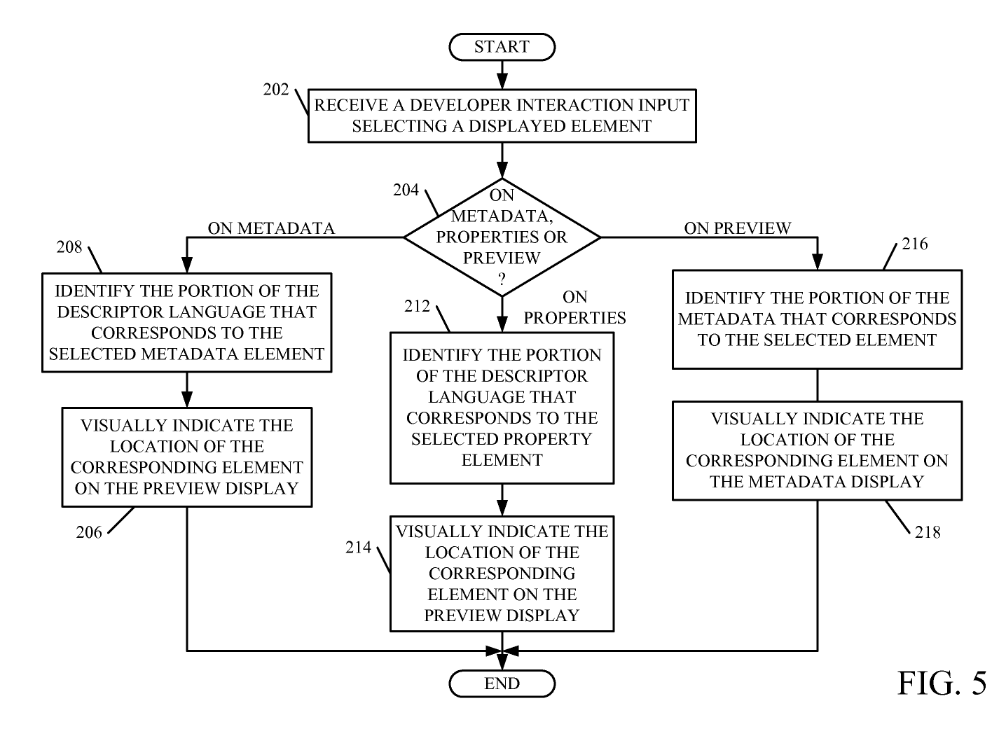

FIG. 5 shows a flow diagram illustrating one example of the operation of system 102 in reflecting a change where developer 112 has simply selected an item in one portion of display 108. User interaction detector 132 first receives the developer interaction input selecting a display element. This is indicated by block 202 in FIG. 5.

It determines whether that change was on the metadata display section 114, the properties display section 116, or the preview display section 118. This is indicated by block 204. If it was on metadata display section 114, then detector 132 identifies the portion of the descriptor language that corresponds to the selected metadata element. This is indicated by block 206 in FIG. 5. It then visually indicates the location of the corresponding element on the preview display. This is indicated by block 208.

By way of example, it can be seen in FIG. 4A that developer 110 has selected the node in metadata structure 160 representing the “GTA vendor” control 164. This can be seen because that node is highlighted by box 210 in FIG. 4A. In that case, detector 132 identifies the portion of the descriptor language generated by form compiler 130 that corresponds to that metadata node and provides it to preview generator 126. This can be done using pointers, a cross-reference analysis or in other ways. Preview generator 126 then visually indicates that the developer 112 has selected node 210, on preview display section 118. It can be seen in FIG. 4A, for instance, that the control 164 in the preview display is now highlighted or bolded, to reflect that developer 112 has selected that corresponding node in metadata structure 160.

The same general processing occurs if the developer selects a property value 162 in property display section 116. Detector 132 first identifies the portion of the descriptor language that corresponds to the selected property element. This is indicated by block 212 in FIG. 5. Again, this can be done using pointers, other kinds of cross-reference techniques, etc. It then visually indicates the location of the corresponding element on the preview display section 118. This is indicated by block 214.

As an example, assume that developer 112 selected the property 162 corresponding to the label of the “Certificate Number” control 170 on preview display 118. If that is the case, then this is indicated by detector 132 to preview generator 126, and preview generator 126 then visually indicates that on preview display section 118. For example, it may highlight or bold or otherwise visually indicate the label “Certificate Number” for control 170.

A similar processing occurs with respect to the user selecting an element on preview display section 118. For instance, assume that the user has selected the control 164 on display section 118. Detector 132 identifies the portion of the metadata that corresponds to the selected preview element. This is indicated by block 216 in FIG. 5. It then provides this to user interface component 128 and instructs user interface component 128 to visually indicate the location of the corresponding element on the metadata display 114. This is indicated by block 218 in FIG. 5. As an example, assume that the developer 112 has selected control 164 on preview display 118. In that case, detector 132 controls user interface component 128 to highlight the corresponding node 210 in metadata structure 160 that corresponds to the selected control 164.

This can be very useful. For instance, some forms have hundreds or thousands of different controls. Therefore, the property list and metadata structure are very long and complicated. It can be difficult for a developer to find the precise metadata element or property he or she wishes to modify. If the developer can simply select an item on the preview display section 118 and have the system highlight that portion of the metadata structure, this can increase the productivity of the developer. Similarly, if the developer can highlight a section of either the metadata structure or the properties and have the system identify that part of the previewed form, that can also increase productivity. Similarly, if the user selects a property either from the properties display section 116 or on preview display 118, and the system correspondingly highlights the other display, that can increase productivity as well.

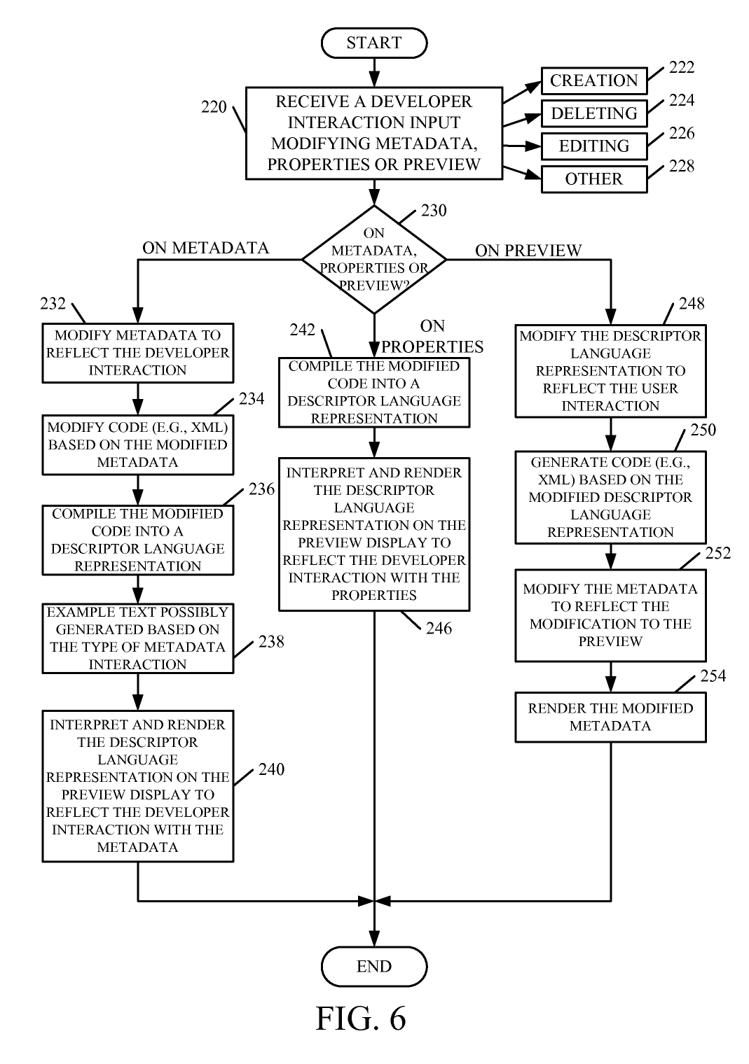

FIG. 6 is a flow diagram illustrating one example of the operation of the system shown in FIG. 1 in receiving an authoring input from developer 112. Thus, in the example described with respect to FIG. 6, the developer 112 is not simply selecting an item from one of the display sections, but developer 112 is actually providing a development input (e.g., creating, deleting or modifying something). Receiving the developer interaction input developing metadata, properties or the preview display is indicated by block 220 in FIG. 6. The input interaction can be a creation input 222, a deletion input 224, an editing input 226, or another input 226.

The system then determines whether the interaction input was on the metadata, properties or preview display sections of the user interface display 108. This is indicated by block 230. If it was on the metadata display section 114, then metadata authoring functionality 124 modifies the metadata structure 160 to reflect the developer interaction input. This is indicated by block 232. When form compiler 130 next compiles the change, it modifies the code (e.g., the XML) based on the modified metadata. This is indicated by block 234. The modified metadata is compiled into the descriptor language representation as indicated by block 236. In addition, in one example, example text can be generated for the modified form, based upon the type of metadata interaction. This is indicated by block 238. By way of example, if developer 112 adds a text field, then example text can be generated and placed in that field so the developer can better see how the form will appear during runtime.

Preview generator 126 then interprets and renders the descriptor language representation on the preview display section 118 to reflect the developer interaction with the metadata. This is indicated by block 240 in FIG. 6.

Referring again to FIG. 4A, as an example, assume that developer 112 deletes node 210 from metadata structure 160. In that case, based upon the processing described with respect to FIG. 6, preview generator 126 will (in near real time as soon as compilation occurs) delete control 164 from the preview shown on preview display section 118. Thus, developer 112 can see the effect of his or her development inputs on metadata structure section 160.

The same is generally true if developer 112 makes a modification or other development input to properties 162 in property display section 116. Metadata authoring functionality 124 first modifies the code (e.g., the XML) based on the property interaction. This is indicated by block 242 in FIG. 6. Form compiler 130 then compiles the modified code into the descriptor language representation, as indicated by block 244. Preview generator 126 then interprets and renders the descriptor language representation on the preview display section 118 to reflect the developer interaction with the properties. This is indicated by block 246.

Referring again to FIG. 4A as an example, assume that developer 112 changes the name or label property corresponding to control 166 from “source” to “destination”. In that case, based on the processing described with respect to FIG. 6, preview generator 126, in near real time, after the change is compiled by compiler 130, shows that change on the form preview displayed on preview display section 118. Thus, again, developer 112 gets near real time feedback as to how his or her development inputs will affect the displayed form.

In one example, the same is true if developer 112 makes changes on the preview displayed on preview display section 118. For instance, assume that developer 112 clicks on control 164 and deletes it from preview display section 118. In that case, form compiler 130 modifies the descriptor language representation to reflect the user interaction. This is indicated by block 248. It then generates code (e.g., XML) based upon the modified descriptor language representation as indicated by block 250 and metadata authoring functionality 124 modifies the metadata structure 160 to reflect the modification made to the preview in preview section 118. This is indicated by block 252. It then renders the modified metadata structure 160, as indicated by block 254. Thus, if the developer 112 makes changes on the preview display 118, those changes are automatically reflected back in the metadata structure 160 and properties 162.

It should be noted that the descriptor language can take a wide variety of different forms. In one example, the descriptor language representation of the form is a static representation of the form that contains the form control hierarchy along with a set of properties and other optional data binding information. It can be run by a browser (e.g., browser 148 in preview generator 126) in order to generate a renderable version of the form without necessarily having all the underlying data, logic results, behaviors, state information, etc. The static representation may be implemented in a JavaScript Object Notation (JSON) format, for instance.

FIG. 7 is a flow diagram illustrating one embodiment of environment 100 in allowing developer 112 to dock and undock various portions of display 108. As an example, each of the display sections 114, 116 and 118 are illustratively configured so that they can be undocked and separately moved around the display. Therefore, docking control component 136 first receives a user undocking input on a selected pane (or display section) of a user interface display 108. This is indicated by block 260 in FIG. 7. The undocking input can take a wide variety of different forms. For instance, if developer 112 is using a point and click device, the undocking input may be click and hold as indicated by block 262. If the developer is using touch gestures, the undocking input may be a touch and hold gesture as indicated by block 264. It can be a wide variety of other inputs 266 as well.

By way of example, and referring again to FIG. 4A, assume that developer 112 clicks on and holds display section 118. In that case, docking control component 136 determines that this is an undocking input indicating that developer 112 wishes to undock preview display section 118 from the other portions of display 108.

Component 136 then receives a relocation input as indicated by block 268. For instance, developer 112 may provide a drag and drop input as indicated by block 270, or another relocation input as indicated by block 272, indicating that developer 112 wishes to move the location of the undocked preview section 118.

Docking control component 136 then receives a re-dock input indicating that developer 112 wishes to re-dock the previously undocked preview section 118 at the new location. This is indicated by block 274. For instance, developer 112 may drag the preview section 118 to a different portion of the current display device (e.g., to a different portion of the developer's monitor). This is indicated by block 276. In another embodiment, developer 112 may invoke multi-monitor functionality that allows developer 112 to drag the preview section to a second monitor so that developer 112 can view more of the previewed form. This is indicated by block 278. The re-docking and relocation inputs can be other inputs as well, and this is indicated by block 280.

It can thus be seen that the detection of inputs from developer 112 on any of the display sections generated by the development system can be reflected on other display sections. This can significantly increase the productivity of developer 112, as it can quickly direct the developer's attention to the portion of the metadata or code that has been modified or selected. It can also quickly show the developer 112 the visual effect of his or her development inputs on the form being developed.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

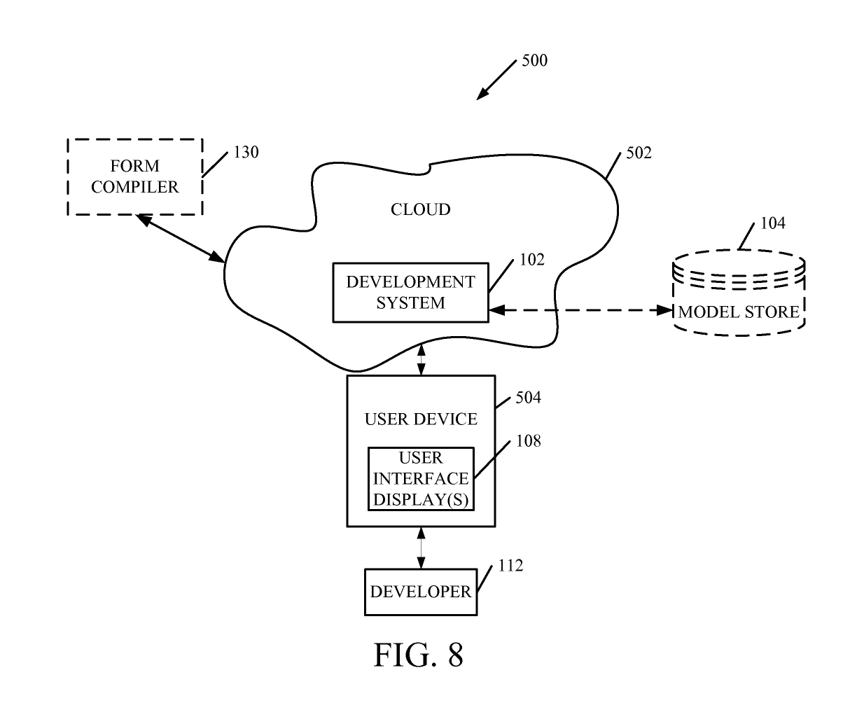

FIG. 8 is a block diagram of environment 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of environment 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 8, some items are similar to those shown in FIG. 1 and they are similarly numbered. FIG. 8 specifically shows that system 102 is located in cloud 502 (which can be public, private, or a combination where portions are public while others are private). Therefore, developer 112 uses a user device 504 to access those systems through cloud 502.

FIG. 8 also depicts another embodiment of a cloud architecture. FIG. 8 shows that it is also contemplated that some elements of system 102 can be disposed in cloud 502 while others are not. By way of example, data store 104 can be disposed outside of cloud 502, and accessed through cloud 502. In another embodiment, form compiler 130 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

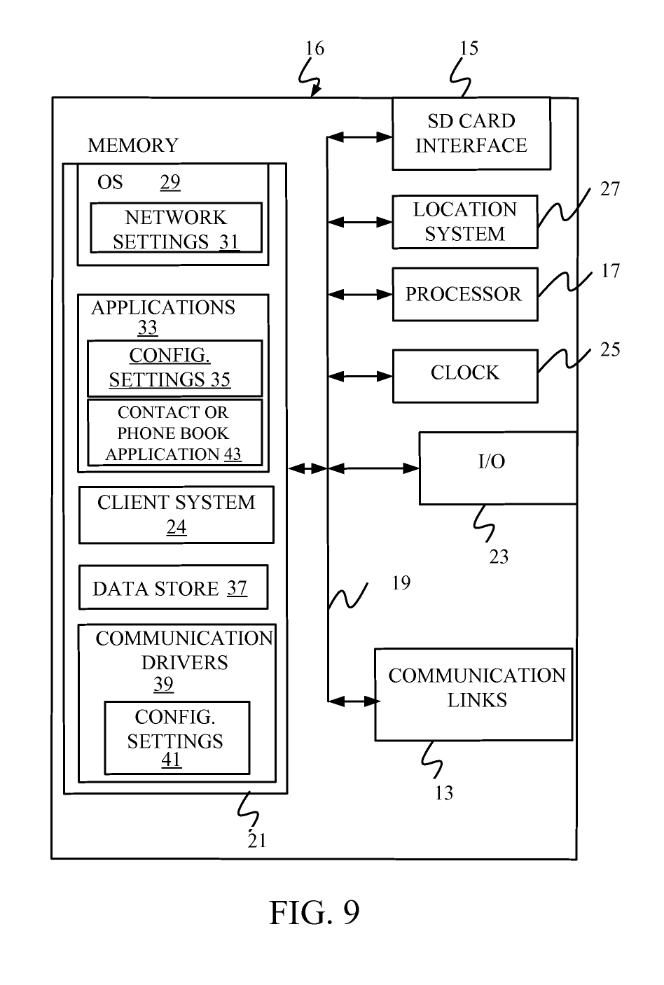

FIG. 9 is a simplified block diagram of one illustrative embodiment of a handheld or mobile computing device that can be used as a user's or client's hand held device 16, in which the present system (or parts of it) can be deployed. FIGS. 8-9 are examples of handheld or mobile devices.

FIG. 9 provides a general block diagram of the components of a client device 16 that can run components system 102 or that interacts with system 102, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 122 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, client system 24, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 102 system 24 which can run various business applications or embody parts or all of system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

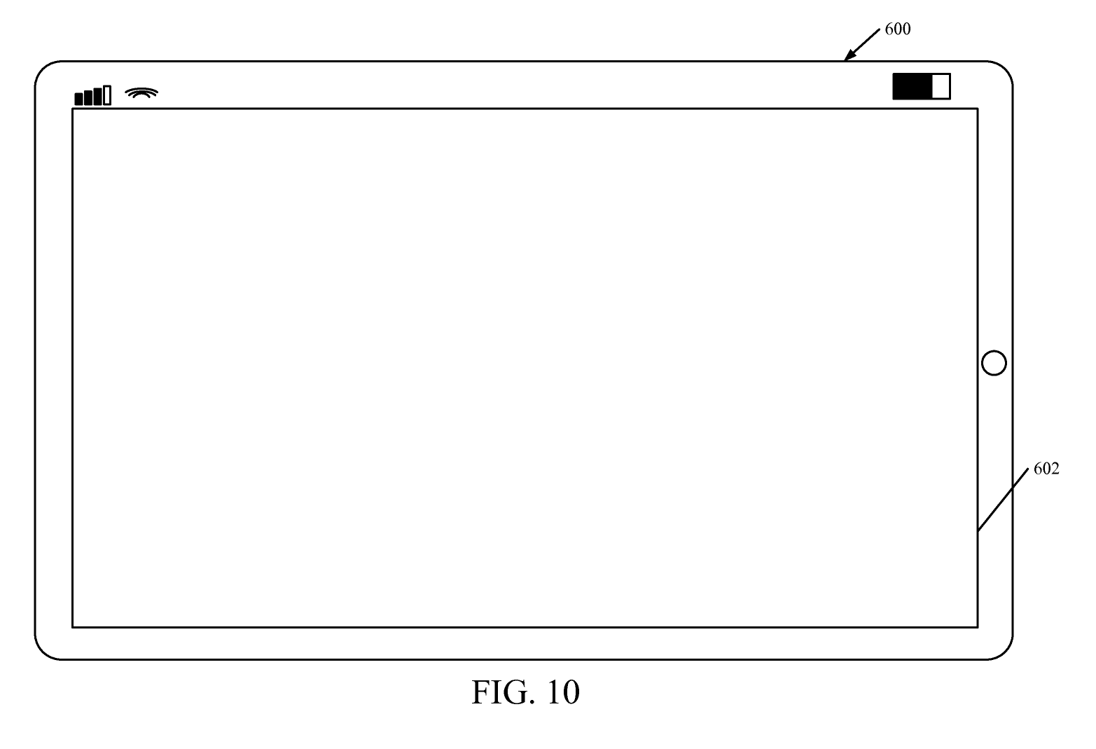

FIG. 10 shows one embodiment in which device 16 is a tablet computer 600. In FIG. 10, computer 600 is shown with the display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 that can also be used. Device 16 can be, for example, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some example, the phone also includes a Secure Digital (SD) card slot 55 that accepts a SD card.

The mobile device can also be is a personal digital assistant (PDA), or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

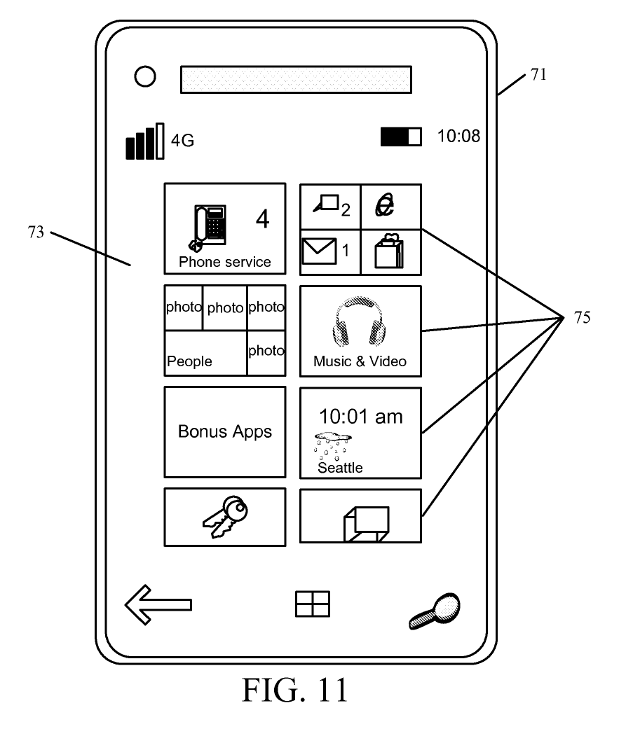

FIG. 11 shows an example of smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

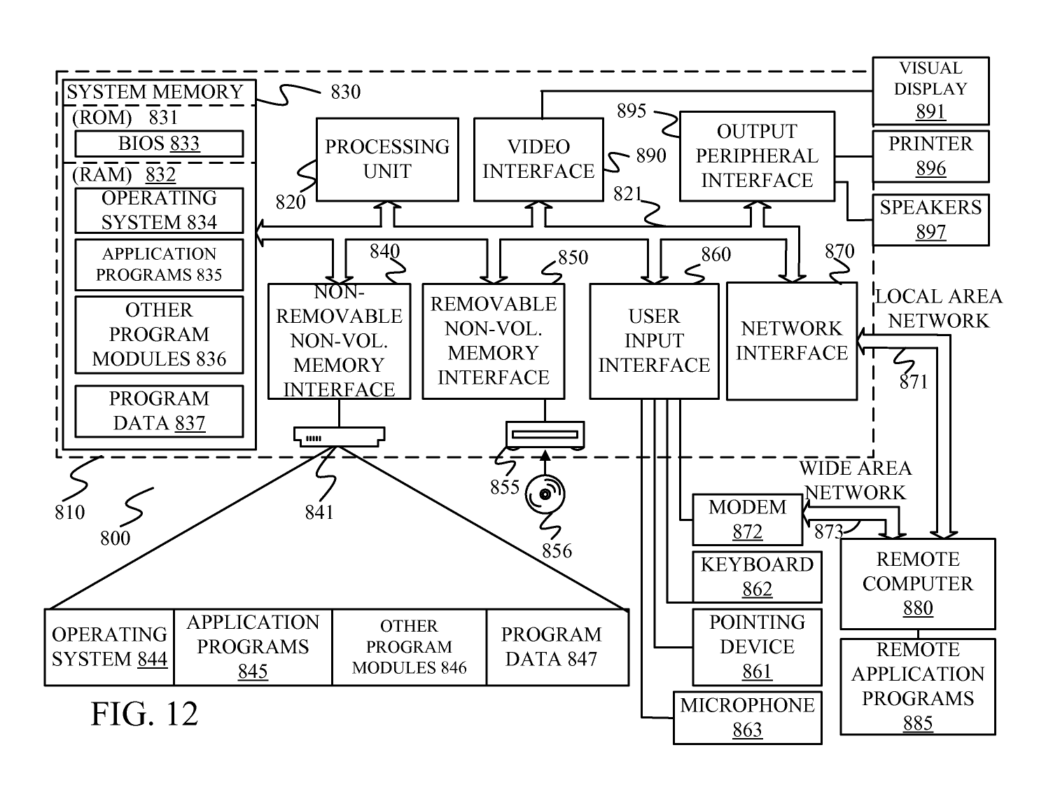

FIG. 12 is one embodiment of a computing environment in which system 102, or parts of it, (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 122), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a development computing system, comprising:

a metadata authoring system configured to generate a metadata display portion of a form authoring display, the metadata display portion displaying a metadata structure that defines a form in a computing system under development;

a preview generator configured to generate a preview display portion of the form authoring display, the preview display portion displaying a preview of the form; and

a user interface component rendering the form authoring display with the metadata display portion and the preview display portion.

Example 2 is the development computing system of any or all previous examples wherein the metadata authoring system is configured to generate a properties display portion of the form authoring display, the properties display portion displaying properties that further define the form in the computing system under development.

Example 3 is the development computing system of any or all previous examples and further comprising:

a user interface detector component configured to detect user interaction with a given portion of the form authoring display and control the user interface component to visually reflect the user interaction on another portion of the form authoring display.

Example 4 is the development computing system of any or all previous examples wherein the preview generator comprises a browser and further comprising:

a form compiler configured to compile the metadata and properties into a descriptor language representation of the form.

Example 5 is the development computing system of any or all previous examples wherein the preview generator comprises:

a descriptor language interpreter configured to receive the descriptor language representation of the form and generate an interpreted representation of the form, based on the descriptor language representation of the form, that is provided to the browser for rendering the preview of the form.

Example 6 is the development computing system of any or all previous examples wherein the preview includes a set of display elements defined by the metadata and properties and wherein the detected user interaction comprises user selection of a display element on the preview and wherein the user interface detector is configured to visually reflect the detected user selection by visually identifying the metadata or property, in the metadata display portion or the property display portion, respectively, that defines the selected display element.

Example 7 is the development computing system of any or all previous examples wherein the preview includes a set of display elements defined by the metadata and properties and wherein the detected user interaction comprises user modification of a display element on the preview and wherein the user interface detector is configured to visually reflect the detected user modification by visually modifying the metadata or property, in the metadata display portion or the property display portion, respectively, that defines the modified display element.

Example 8 is the development computing system of any or all previous examples wherein the preview includes a set of display elements defined by the metadata and properties and wherein the detected user interaction comprises user selection of a portion of metadata on the metadata display portion or a property on the properties display portion and wherein the user interface detector is configured to visually reflect the detected user selection by visually identifying the display element in the preview display portion defined by the selected portion of metadata or the selected property.

Example 9 is the development computing system of any or all previous examples wherein the preview includes a set of display elements defined by the metadata and properties and wherein the detected user interaction comprises user modification of a portion of metadata on the metadata display portion or a property on the properties display portion and wherein the user interface detector is configured to visually reflect the detected user modification by visually modifying the display element in the preview display portion defined by the modified portion of metadata or the modified property.

Example 10 is the development computing system of any or all previous examples and further comprising:

a docking control component configured to receive an undocking user input corresponding to a given display portion comprising one of the metadata display portion, the preview display portion and the properties display portion, and a relocation input, and to control the user interface component to visually undock the given display portion from the form authoring display and relocate the given display portion to a visual location identified by the relocation input.

Example 11 is the development computing system of claim 3 wherein the preview generator comprises:

a sample text generator configured to generate sample text displayed in the preview of the form.

Example 12 is a method, comprising:

generating a metadata display portion of a form authoring display, the metadata display portion displaying a metadata structure that defines display elements on a form;

generating a preview display portion of the form authoring display, the preview display portion displaying a preview of the form, showing the display elements; and

rendering the form authoring display, in a development system, with the metadata display portion and the preview display portion.

Example 13 is the method of any or all previous examples and further comprising:

generating a properties display portion of the form authoring display, the properties display portion displaying properties that further define the display elements on the form.

Example 14 is the method of any or all previous examples and further comprising:

detecting user interaction with a given portion of the form authoring display; and

visually reflecting the user interaction on another portion of the form authoring display.

Example 15 is the method of any or all previous examples wherein detecting user interaction comprises detecting user interaction with a given display element on the preview of the form and wherein visually reflecting comprises:

visually reflecting the detected user interaction by visually identifying the metadata or property, in the metadata display portion or the property display portion, respectively, that defines the given display element.

Example 16 is the method of any or all previous examples wherein detecting user interaction comprises detecting user interaction with a given portion of metadata on the metadata display portion or a given property on the properties display portion and wherein visually reflecting comprises:

visually reflecting the detected user interaction by visually identifying the display element in the preview display portion defined by the given portion of metadata or the given property.

Example 17 is the method of any or all previous examples and further comprising:

receiving an undocking user input corresponding to a given display portion comprising one of the metadata display portion, the preview display portion and the properties display portion;

receiving a relocation user input; and

visually relocating the given display portion to a visual location identified by the relocation input.

Example 18 is the method of any or all previous examples wherein generating the preview display portion comprises:

generating sample text displayed in the preview of the form.

Example 19 is a computer readable storage medium that stores computer executable instructions which, when executed by a computer, cause the computer to perform a method, comprising:

generating a metadata display portion of a form authoring display, the metadata display portion displaying a metadata structure that defines display elements on a form;

generating a preview display portion of the form authoring display, the preview display portion displaying a preview of the form, showing the display elements;

rendering the form authoring display, in a development system, with the metadata display portion and the preview display portion;

detecting user interaction with a given portion of the form authoring display; and

visually reflecting the user interaction on another portion of the form authoring display.

Example 20 is the computer readable storage medium of any or all previous examples and further comprising:

receiving an undocking user input corresponding to a given display portion comprising one of the metadata display portion and the preview display portion;

receiving a relocation user input; and

visually relocating the given display portion to a visual location identified by the relocation input.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A development computing system, comprising:
a metadata authoring system configured to generate a metadata display portion of a form authoring display, the metadata display portion displaying a metadata structure that defines a form in a computing system under development;
a preview generator configured to generate a preview display portion of the form authoring display, the preview display portion displaying a preview of the form; and
a user interface component rendering the form authoring display with the metadata display portion and the preview display portion.

2. The development computing system of claim 1 wherein the metadata authoring system is configured to generate a properties display portion of the form authoring display, the properties display portion displaying properties that further define the form in the computing system under development.

3. The development computing system of claim 2 and further comprising:
a user interface detector component configured to detect user interaction with a given portion of the form authoring display and control the user interface component to visually reflect the user interaction on another portion of the form authoring display.

4. The development computing system of claim 3 wherein the preview generator comprises a browser and further comprising:
a form compiler configured to compile the metadata and properties into a descriptor language representation of the form.

5. The development computing system of claim 4 wherein the preview generator comprises:
a descriptor language interpreter configured to receive the descriptor language representation of the form and generate an interpreted representation of the form, based on the descriptor language representation of the form, that is provided to the browser for rendering the preview of the form.

6. The development computing system of claim 3 wherein the preview includes a set of display elements defined by the metadata and properties and wherein the detected user interaction comprises user selection of a display element on the preview and wherein the user interface detector is configured to visually reflect the detected user selection by visually identifying the metadata or property, in the metadata display portion or the property display portion, respectively, that defines the selected display element.

7. The development computing system of claim 3 wherein the preview includes a set of display elements defined by the metadata and properties and wherein the detected user interaction comprises user modification of a display element on the preview and wherein the user interface detector is configured to visually reflect the detected user modification by visually modifying the metadata or property, in the metadata display portion or the property display portion, respectively, that defines the modified display element.

8. The development computing system of claim 3 wherein the preview includes a set of display elements defined by the metadata and properties and wherein the detected user interaction comprises user selection of a portion of metadata on the metadata display portion or a property on the properties display portion and wherein the user interface detector is configured to visually reflect the detected user selection by visually identifying the display element in the preview display portion defined by the selected portion of metadata or the selected property.

9. The development computing system of claim 3 wherein the preview includes a set of display elements defined by the metadata and properties and wherein the detected user interaction comprises user modification of a portion of metadata on the metadata display portion or a property on the properties display portion and wherein the user interface detector is configured to visually reflect the detected user modification by visually modifying the display element in the preview display portion defined by the modified portion of metadata or the modified property.

10. The development computing system of claim 3 and further comprising:
a docking control component configured to receive an undocking user input corresponding to a given display portion comprising one of the metadata display portion, the preview display portion and the properties display portion, and a relocation input, and to control the user interface component to visually undock the given display portion from the form authoring display and relocate the given display portion to a visual location identified by the relocation input.

11. The development computing system of claim 3 wherein the preview generator comprises:
a sample text generator configured to generate sample text displayed in the preview of the form.

12. A method, comprising:
generating a metadata display portion of a form authoring display, the metadata display portion displaying a metadata structure that defines display elements on a form;
generating a preview display portion of the form authoring display, the preview display portion displaying a preview of the form, showing the display elements; and
rendering the form authoring display, in a development system, with the metadata display portion and the preview display portion.

13. The method of claim 12 and further comprising:
generating a properties display portion of the form authoring display, the properties display portion displaying properties that further define the display elements on the form.

14. The method of claim 3 and further comprising:
detecting user interaction with a given portion of the form authoring display; and
visually reflecting the user interaction on another portion of the form authoring display.

15. The method of claim 14 wherein detecting user interaction comprises detecting user interaction with a given display element on the preview of the form and wherein visually reflecting comprises:
visually reflecting the detected user interaction by visually identifying the metadata or property, in the metadata display portion or the property display portion, respectively, that defines the given display element.

16. The method of claim 14 wherein detecting user interaction comprises detecting user interaction with a given portion of metadata on the metadata display portion or a given property on the properties display portion and wherein visually reflecting comprises:
visually reflecting the detected user interaction by visually identifying the display element in the preview display portion defined by the given portion of metadata or the given property.

17. The method of claim 14 and further comprising:
receiving an undocking user input corresponding to a given display portion comprising one of the metadata display portion, the preview display portion and the properties display portion;
receiving a relocation user input; and
visually relocating the given display portion to a visual location identified by the relocation input.

18. The method of claim 14 wherein generating the preview display portion comprises:
generating sample text displayed in the preview of the form.

19. A computer readable storage medium that stores computer executable instructions which, when executed by a computer, cause the computer to perform a method, comprising:
generating a metadata display portion of a form authoring display, the metadata display portion displaying a metadata structure that defines display elements on a form;
generating a preview display portion of the form authoring display, the preview display portion displaying a preview of the form, showing the display elements;
rendering the form authoring display, in a development system, with the metadata display portion and the preview display portion;
detecting user interaction with a given portion of the form authoring display; and
visually reflecting the user interaction on another portion of the form authoring display.

20. The computer readable storage medium of claim 19 and further comprising:
receiving an undocking user input corresponding to a given display portion comprising one of the metadata display portion and the preview display portion;
receiving a relocation user input; and
visually relocating the given display portion to a visual location identified by the relocation input.
